(19) United States
(12) Patent Application Publication
(10) Pub. No.: US 2006/0021056 A1
(43) Pub. Date: Jan. 26, 2006

(54) Digital rights management user data transfer

(75) Inventor: Eckhart Koppen, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation, NOKIA GROUP (FI)

(21) Appl. No.: 10/883,359

(22) Filed: Jun. 30, 2004

(51) Int. Cl. H04N 7/16

(52) U.S. Cl. 726/26

(57) ABSTRACT

A method, device, and system use a transfer module that is distributed and used in a controlled manner. This transfer module has sufficient access rights to de-crypt and re-encrypt content to perform the unbinding and binding operations needed to transfer content from one terminal to another. Assuming a back-up copy of relevant data is kept by the user, the back-up copy is encrypted with a key of a trusted party. The encrypted data can be transferred to a new device. The corresponding decryption key is transferred from the trusted party to the new device along with the transfer module.

### FIELD OF THE INVENTION

The present invention relates to digital rights management and device management. More particularly, the present invention relates to a digital rights management user data transfer.

### BACKGROUND OF THE INVENTION

Digital Rights Management (“DRM”) is a term used to describe a range of techniques that use information about rights and rightsholders to manage copyright material and the terms and conditions on which it is made available to users. More specifically, DRM involves the description, layering, analysis, valuation, trading, and monitoring of an owner's property rights to an asset. DRM covers the management of the digital rights to the physical manifestation of a work (e.g., a textbook) or the digital manifestation of a work (e.g., a Web page). DRM also covers the management of an asset whether the asset has a tangible or an intangible value. Current DRM technologies include languages for describing the terms and conditions for an asset, tracking asset usage by enforcing controlled environments or encoded asset manifestations, and closed architectures for the overall management of the digital rights.

In general, DRM protection is based on the principle that every end-entity able to consume DRM protected content is equipped with a cryptographic key, which usually is unique for every end-entity. DRM protected content is distributed, possibly together with a set of consumption rights, in encrypted form. Thus, only authorized parties, usually those that have paid for the content, are able to consume the content. This is done, for example, by encrypting the content with the public key matching the recipient's private DRM key (asymmetric key encryption). For practical reasons, usually a hybrid scheme is chosen, wherein DRM protected content is encrypted under a content encryption key (CEK) using symmetric encryption. The CEK in turn is then encrypted with the public DRM key matching the recipient's private DRM key. The CEK may be accompanied by consumption rights (which may also be encrypted) expressing the usage rules for the DRM protected content.

The effect is the same for both approaches, i.e., only authorized parties are able to consume the DRM protected content (if implemented securely and correctly). The two approaches, however, also share a drawback originating from the fact that every end-entity is equipped with a unique DRM key: content (or the CEK) has to be personalized for every device prior to consumption.

Usually, DRM content is protected (using encryption, for example) by the network side for various reasons, e.g., to guarantee payment for the content. Typically, the network infrastructure has a server for personalizing content transported in the wireless network. The network centric nature of current approaches, however, is not very suitable for certain types of content, e.g., free content. The most prominent example being content intended for preview purposes.

Accordingly, it is usually the case that the transfer of purchased, digital rights management (DRM)-protected content from one terminal to another cannot be performed by the end user of a terminal. Typically, the rights holders for the content want to enforce certain usage rights over content management, and this includes in most cases control over how content can be copied and which technical and security requirements have to be met. One challenge lies in creating a trusted environment in which such a transfer can be performed. DRM content bound to a specific terminal via the terminal specific DRM Database Key could not be transferred to another terminal, unless technical mechanisms were available to retrieve the key from an existing terminal. Such a transfer is not possible if the key is stored in a secure area on the terminal or the terminal is not functioning any more. Performing a content transfer requires that the content binding to the original terminal is removed and a new binding to the new terminal is established. Otherwise, the rights holder (the content owner) must re-issue the content to the end user.

Thus, there is a need to introduce a transfer module which is distributed and used in a controlled manner. Further, there is a need for a transfer module with sufficient access rights to decrypt and re-encrypt content to perform the unbinding and binding steps to transfer DRM-protected content. Even further, there is a need for improved user data transfer under DRM.

### SUMMARY OF THE INVENTION

The present invention is directed to the use of a transfer module that is distributed and used in a controlled manner. This transfer module has sufficient access rights to de-crypt and re-encrypt content to perform the unbinding and binding operations needed to transfer content from one terminal to another. Assuming a back-up copy of relevant data is kept by the user, the back-up copy is encrypted with a key of a trusted party. The encrypted data can be transferred to a new device. The corresponding decryption key is transferred from the trusted party to the new device along with the transfer module.

Briefly, one exemplary embodiment relates to a method of transferring data subject to digital rights management limitations. The method includes obtaining data subject to digital rights management limitations from an original terminal at a replacement terminal, obtaining a transfer module at the replacement terminal from a trusted source, loading the transfer module onto the replacement terminal, decrypting the data subject to digital rights management limitations using a key provided by the transfer module, and encrypting the data subject to digital rights management limitations.

Another exemplary embodiment relates to a device that transfers data subject to digital rights management limitations. The device includes a digital rights management user data transfer module that handles the transfer of user data subject to the digital rights management limitations and a digital rights management rights server that manages rights stored on the device by decrypting the data subject to digital rights management limitations using a key from the digital rights management user data transfer module and encrypting the data subject to digital rights management limitations.

Yet another exemplary embodiment relates to a system for transferring data subject to digital rights management limitations. The system includes an original terminal having a first rights database containing data subject to digital rights management limitations; a replacement terminal having an encrypted rights database and a second rights database; and a trusted entity that communicates a transfer module to the replacement terminal. The transfer module provides a key to enable the replacement terminal to decrypt data subject to digital rights management limitations communicated from the original terminal.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a diagram showing a transfer module which performs the secure transfer of digital rights management (DRM) user data from one terminal to another in accordance with an exemplary embodiment.

FIG. 2 is a flow diagram depicting operations performed in the secure transfer of digital rights management (DRM) user data from one terminal to another using a transfer module.

FIG. 3 is a diagram representing a system for transferring data subject to digital rights management limitations on copying in accordance with an exemplary embodiment.

### DETAILED DESCRIPTION OF EXEMPLARY EMBODIMENTS

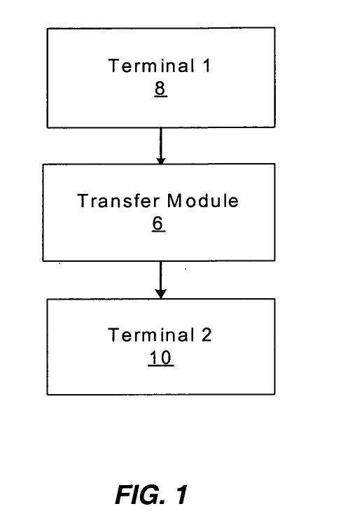

FIG. 1 illustrates a transfer module 6 which enables the secure transfer of digital rights management (DRM) user data from a terminal 8 to a terminal 10. The transfer module 6 handles content files or license files from the terminal 8. The transfer module 6 is preferably a software module provided to the terminal 10 from a communication service provider. The transfer module 6 facilitates the transfer of DRM user data by decrypting and re-encrypting content and license files. In an exemplary embodiment, terminals 8 and 10 are cell phones and the communication service provider is an organization such as the Nokia Customer Care Organization operated by Nokia Corporation of Finland.

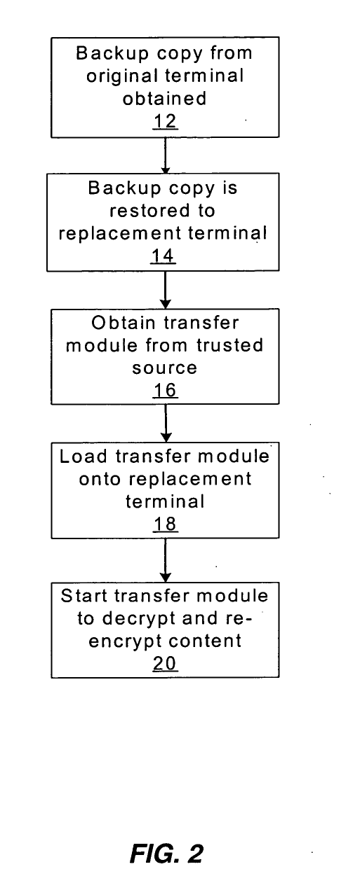

FIG. 2 illustrates operations performed in the secure transfer of DRM user data from one terminal to another using a transfer module. Additional, fewer, or different operations may be performed, depending on the embodiment. In an operation 12, a backup copy of the user data from the original terminal is obtained. The backup copy can be provided either by the user or done as part of the transfer procedure. In an operation 14, the backup copy is restored to or loaded on the replacement terminal.

In an operation 16, a transfer module is obtained from a trusted source, such as a manufacturer or service provider customer service organization. The trusted module can be a software module having encryption key that allows the trusted module to decrypt or encrypt files. In an operation 18, the transfer module is loaded onto the replacement terminal. The loading procedure can be part of a set up operation where the replacement terminal is provided with software applications and/or initialization information necessary for communication on a network.

In an operation 20, the transfer module is started. The transfer module decrypts and re-encrypts content and license data files from the original terminal. The transfer module can handle content files (such as media files) or license data files (holding usage rights and decryption keys for content files). It is assisted by extensions of the DRM system which create a safe data transfer container for license data files if necessary.

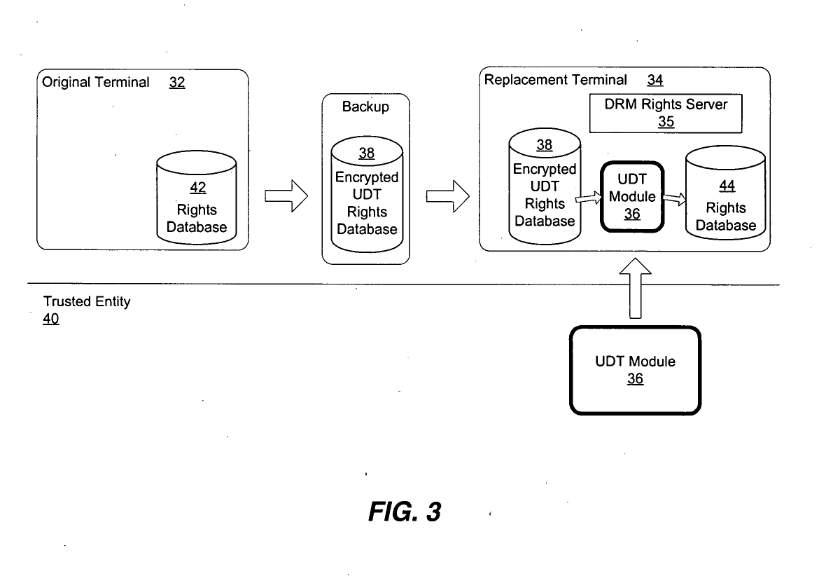

FIG. 3 illustrates a DRM User Data Transfer (UDT) system 30 including two software components and one data container or database used in transferring data between an original terminal 32 and a replacement terminal 34. According to an exemplary embodiment, the software components include a DRM Rights Server 35 which manages the rights stored on the device and the DRM User Data Transfer Module 36 which handles the actual transfer process. The DRM UDT Module 36 is a software component which is installed on the replacement terminal 34. The data container is the DRM User Data Rights Database 38 which represents a transport container for transferring DRM rights between terminals 32 and 34. The UDT system 30 also involves a trusted entity 40, such as a customer care organization of a service provider or a manufacturer.

The DRM Rights Server 35 prepares the UDT Rights Database 38 during a regular backup operation. The UDT Rights Database 38 is a secure file which is saved in a location which is covered by a regular backup. After a completed backup operation, the UDT Rights Database 38 is stored in a safe place, e.g. the user's desktop computer.

The process of creating the UDT Rights Database 38 includes at least two operations. In the first operation, an existing rights database 42 in the original terminal 32 is decrypted by using a RDB specific key, which is usually terminal specific and unique per terminal. Only the DRM Rights Server 35 is able to obtain this key and perform the decrypt operation. In the second operation, the decrypted DRM Rights Database 38 is encrypted with a special UDT Key. The UDT Key can be a symmetric key or the public key of a public/private key par. This encrypted database is the DRM UDT Rights Database 44, it is stored in the file system of the replacement terminal 34.

Performing the actual User Data Transfer is based on the preparations described above. In the UDT case, an existing backup of the original terminal is restored to the replacement terminal. This backup includes the DRM UDT Database, containing the rights which were stored on the original terminal 32. The UDT Rights Database 38 is made available to the DRM Rights Server 35 on the replacement terminal. For this purpose, the entity performing the transfer (e.g. a Nokia Service Point) requests the DRM UDT Module 36 from the trusted entity 40. The trusted entity 40 verifies the request and sends back the DRM UDT Module 36.

In an exemplary embodiment, the DRM UDT Module 36 is launched when the replacement terminal 34 restarts. Its presence is detected by the DRM Rights Server 35 which hands control over to the UDT Module 36. The UDT Module contains the UDT Key (either a symmetric key or the private key of a public/private key pair) and can therefore decrypt the UDT RDB which was restored previously to the replacement terminal. After decrypting it, it encrypts it with the terminal RDB key, deletes itself and restarts the terminal. The newly encrypted Rights Database is now ready for usage.

In an alternative embodiment, no rights database is used, however content from the original terminal 32 is encrypted directly with a terminal specific key. As such, the same operations are performed as described with reference to FIGS. 1-3, but instead of decrypting and re-encrypting the rights database, the actual content files are processed on the replacement terminal.

This detailed description outlines exemplary embodiments of a method, device, and system for transferring data subject to digital rights management (DRM) limitations. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

What is claimed is:

1. A method of transferring data subject to digital rights management limitations, the method comprising:
obtaining data subject to digital rights management limitations from an original terminal at a replacement terminal;
obtaining a transfer module at the replacement terminal from a trusted source;
loading the transfer module onto the replacement terminal;
decrypting the data subject to digital rights management limitations using a key provided by the transfer module; and
encrypting the data subject to digital rights management limitations.

2. The method of claim 1, wherein obtaining data subject to digital rights management limitations from an original terminal at a replacement terminal comprises:
obtaining a backup copy of data subject to digital rights management limitations from an original terminal; and
communicating the backup copy to a replacement terminal.

3. The method of claim 2, the backup copy is provided by a user of the original terminal.

4. The method of claim 1, wherein the data subject to digital rights management limitations comprises content and license data files.

5. The method of claim 1, wherein the data subject to digital rights management limitations is encrypted using a public key of a public/private key pair.

6. The method of claim 1, wherein loading the transfer module onto the replacement terminal comprises communicating with a trusted entity which sends the transfer module to the replacement terminal.

7. The method of claim 1, wherein the data subject to digital rights management limitations is encrypted directly.

8. The method of claim 1, wherein the data subject to digital rights management limitations is located in a rights database.

9. A device that transfers data subject to digital rights management limitations, the device comprising:
a digital rights management user data transfer module that handles the transfer of user data subject to the digital rights management limitations; and
a digital rights management rights server that manages rights stored on the device by decrypting the data subject to digital rights management limitations using a key from the digital rights management user data transfer module and encrypting the data subject to digital rights management limitations.

10. The device of claim 9, further comprising a digital rights management user data rights database that transports data subject to the digital rights management limitations to the device.

11. The device of claim 1 0, wherein the digital rights management user data rights database maintains a backup copy of data subject to the digital rights management limitations from an original device.

12. The device of claim 9, wherein the digital rights management user data transfer module is communicated from a trusted entity and loaded on the device.

13. The device of claim 9, wherein the data subject to digital rights management limitations is encrypted directly.

14. A system for transferring data subject to digital rights management limitations, the system comprising:
an original terminal having a first rights database containing data subject to digital rights management limitations;
a replacement terminal having an encrypted rights database and a second rights database; and
a trusted entity that communicates a transfer module to the replacement terminal, the transfer module providing a key to enable the replacement terminal to decrypt data subject to digital rights management limitations communicated from the original terminal.

15. The system of claim 14, further comprising a user data rights database that transports data subject to the digital rights management limitations from the original terminal to the replacement terminal.

16. The system of claim 15, wherein the user data rights database maintains a backup copy of data subject to the digital rights management limitations from the original terminal.

17. The system of claim 9, wherein the data subject to digital rights management limitations is encrypted directly.

18. The system of claim 14, wherein the transfer module is communicated as part of an initialization procedure.

19. The system of claim 14, wherein the original terminal and the replacement terminal are cell phones.

20. The system of claim 14, further comprising a rights server that manages rights stored on the replacement terminal.

21. A transfer module configured to facilitate communication of data subject to digital rights management limitations, the transfer module comprising:
computer code including identification information; and
a key for decrypting or encrypting data subject to digital rights management limitations on a first terminal, wherein the data is provided, by a second terminal;
wherein the transfer module is loadable onto the second terminal from a trusted source.
